(19) United States
(12) Patent Application Publication
(10) Pub. No.: US 2026/0039238 A1
(43) Pub. Date: Feb. 5, 2026

(54) SYSTEM FOR SECURING A TORQUE TUBE TO A MOUNTING RAIL

(71) Applicant: ARRAY TECH, INC., Albuquerque, NM (US)

(72) Inventors: Benjamin C. de Fresart, Albuquerque, NM (US); Nathan Schuknecht, Golden, CO (US); Thierry Marin-Martinod, Chandler, AZ (US)

(21) Appl. No.: 18/794,772

(22) Filed: Aug. 5, 2024

(51) Int. Cl. H02S 20/20

(52) U.S. Cl. CPC H02S 20/20

(57) ABSTRACT

Embodiments of the present disclosure may include a system for mounting PV modules to a torque tube, the system including a mounting rail, a first strap, a second strap, and a fastener. In some embodiments, the mounting rail may be configured to be secured to the PV module. In some embodiments, the first and second straps may each include a proximal and distal end and a rectangular cross-sectional shape, where a shorter edge of the first and second straps may be configured to interface with the torque tube. In some embodiments, the proximal end of the first and second straps may be coupled to the mounting rail and the distal ends may include a connecting portion. In some embodiments, the system may additionally include a fastener that may couple the connecting portion of the first strap to the connecting portion of the second strap.

### FIELD OF THE INVENTION

The present disclosure generally relates to systems and, in particular, lightweight straps used to secure a torque tube to a mounting rail.

### BACKGROUND

Installation of photovoltaic (PV) modules often requires a PV module frame to be secured to an underlying mounting rail, which is then mounted on a torque tube. A number of different mechanisms may be used to secure the mounting rail to the torque tube. For example, a single strap or clamp may be connected to the mounting rail on one side of the torque tube and wrapped around the torque tube to connect with the mounting rail on an opposite side of the torque tube. The single strap or clamp solution is, however, labor intensive and difficult to attach the torque tube consistently and uniformly with the mounting rail. In addition, the single strap solution may use more material and increase cost as compared with other potential solutions. Further, the single strap solution often creates weak points or failure points at locations where the strap is attached to the mounting rail. By creating failure points, additional material may be needed to reinforce these failure points which further complicates the installation process and leads to an increase in an amount of material used to secure the torque tube to the mounting rail.

To avoid some of the excess material and reinforcement problems with the single strap solutions, other prior solutions have connected the mounting rail to the torque tube using two straps, clamps, or arms. In many of these solutions, both straps typically include top portions and bottom portions, where the top portions may be connected to the mounting rail on respective sides of the torque tube and the bottom portions connect to each other via a connecting mechanism underneath the torque tube. However, this solution, much like the single strap solution, includes straps with significant material cost due to difficulties in reinforcing the design. For example, connecting the bottom portions of the straps together applies a large compression force to the bottom portions of the straps. In response, extra material is needed to reinforce the bottom portions. However, by reinforcing the bottom portions with extra material, the connecting mechanism is forced downward, away from the torque tube. As such, even assuming the compression force connecting the bottom portions of the straps remains constant, the moment felt by one or more other portions of the straps increases. And, increasing the moment applied to other portions of either strap may lead to deformation or failure which may, again, lead to increasing material costs to reinforce the structure. The difficulty in managing material cost, fatigue, stress, and strain on these straps may lead to inconsistent and expensive results which may ultimately lead to damaged torque tubes and PV modules.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used to limit the scope of the claimed subject matter.

Exemplary embodiments of the present disclosure address problems experienced in conventional solar panel tracking systems, including problems associated with the use of straps and clamps to secure torque tubes to mounting rails. Embodiments disclosed herein address these issues by providing a lightweight, two-strap mounting structure that decreases an amount of material used and correspondingly decreases material costs associated with the straps while maintaining a robust structure that is resistant to deformation and failure. In embodiments described herein, individual straps may include a proximal end and a distal end. In some embodiments, the proximal end may include an attaching portion configured to attach the strap to the mounting rail. The distal end of individual straps includes a connecting portion that is configured to connect with another connecting portion of another strap where two straps, in an engaged state, secure the torque tube to the mounting rail. Further, the straps may individually include a cross-sectional shape with a shorter edge and a longer edge. The shorter edge of the strap is configured to interface with the torque tube.

The connecting portions corresponding to each strap may also include a rectangular cross-sectional shape and each is configured to seat a fastener. In some embodiments, the shorter edge of the connecting portion may be configured to engage with a fastener head or other outwardly extending portion of the fastener such that the fastener may apply a compression force on the connecting portion, in an engaged state. In some embodiments, the cross-sectional shape that includes both a shorter and longer edge may allow the connecting portions to withstand the compression forces applied by the fastener without adding more material or increasing a distance of the fastener from the bottom or underside of the torque tube. As such, embodiments disclosed herein include straps with less material and less material cost with increased strength particularly at the connecting portions while keeping the connecting portions close to the bottom or underside of the torque tube.

The object and advantages of the embodiments will be realized and achieved at least by the elements, features, and combinations particularly pointed out in the claims. Both the foregoing summary and the following detailed description are exemplary and explanatory and are not restrictive.

### BRIEF DESCRIPTION OF THE DRAWINGS

Example embodiments will be described and explained with additional specificity and detail through the accompanying drawings in which:

FIG. 1 illustrates an exemplary system for securing a torque tube to a mounting rail;

FIGS. 2A-2C illustrate various views of the straps;

FIGS. 3A-3D illustrate the fastener connecting the first and second straps;

FIGS. 4A-4B illustrate exemplary attaching portions or mechanisms for attaching the first and second straps to the mounting rail; and

FIGS. 5A-5C illustrate an example configuration of the straps including a connecting portion capable of accommodating a T-bolt to connect the first and second straps around a torque tube;

all in accordance with one or more embodiments in the present disclosure.

### DETAILED DESCRIPTION

Embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

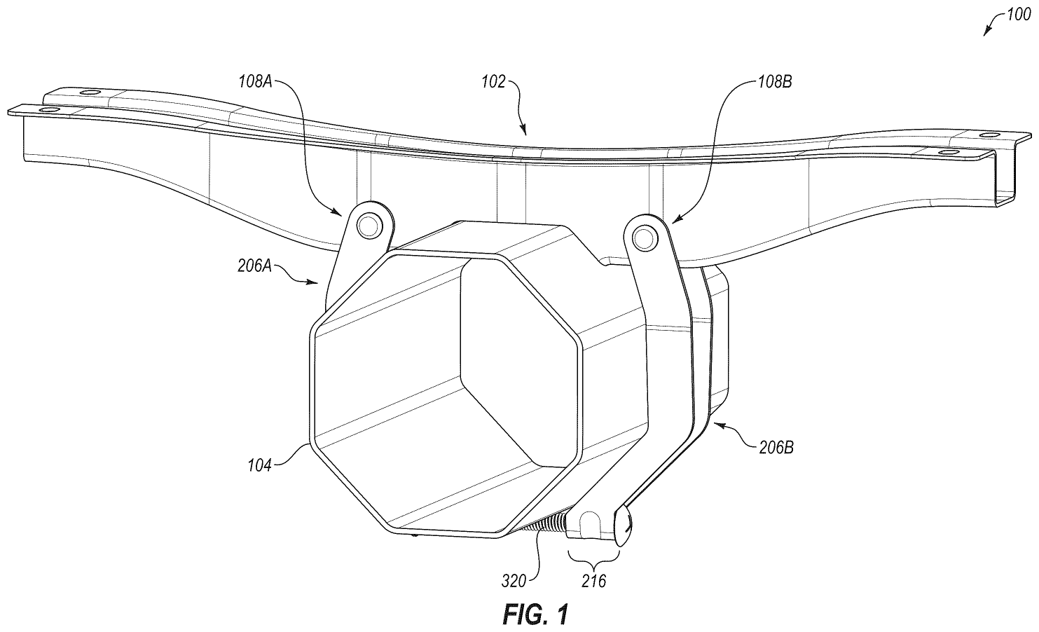

FIG. 1 illustrates an exemplary system 100 for securing a torque tube 104 to a mounting rail 102 using straps 206. The torque tube 104 includes one or more tubular structures that may be configured to attach to a mounting rail 102 and rotate, such that the rotation of the torque tube 104 may also rotate the mounting rail 102. As shown in FIG. 1, the torque tube 104 includes an octagonal cross section. The torque tube 104 shown in FIG. 1 is provided as an example and it not meant to be limiting. The torque tube 104 may include any number of cross-sectional shapes including octagonal, hexagonal, square, circular, etc. In some embodiments, the size, shape, and position of the torque tube 104 may change depending on the configuration of the solar power system in which the torque tube 104 may be used.

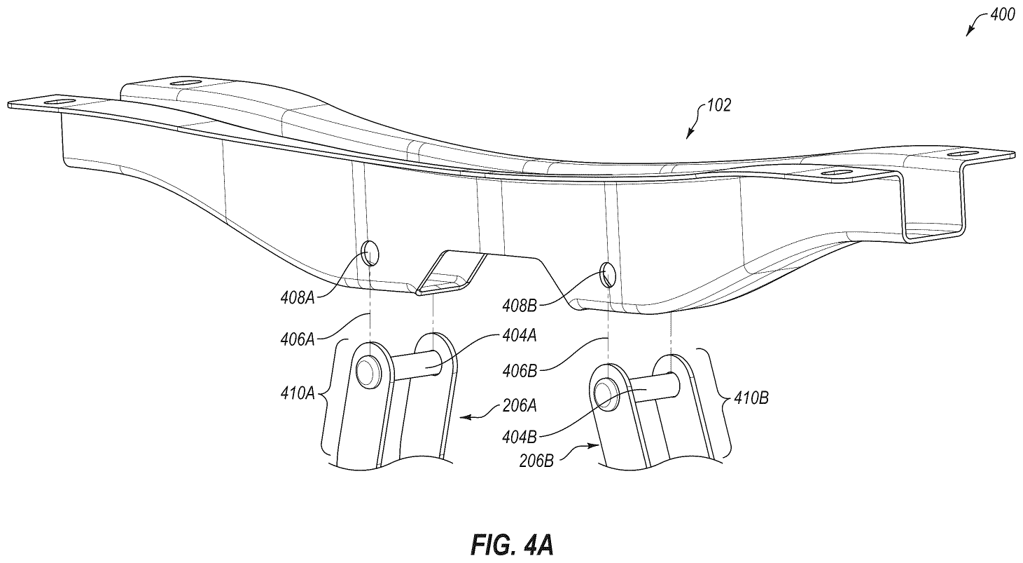

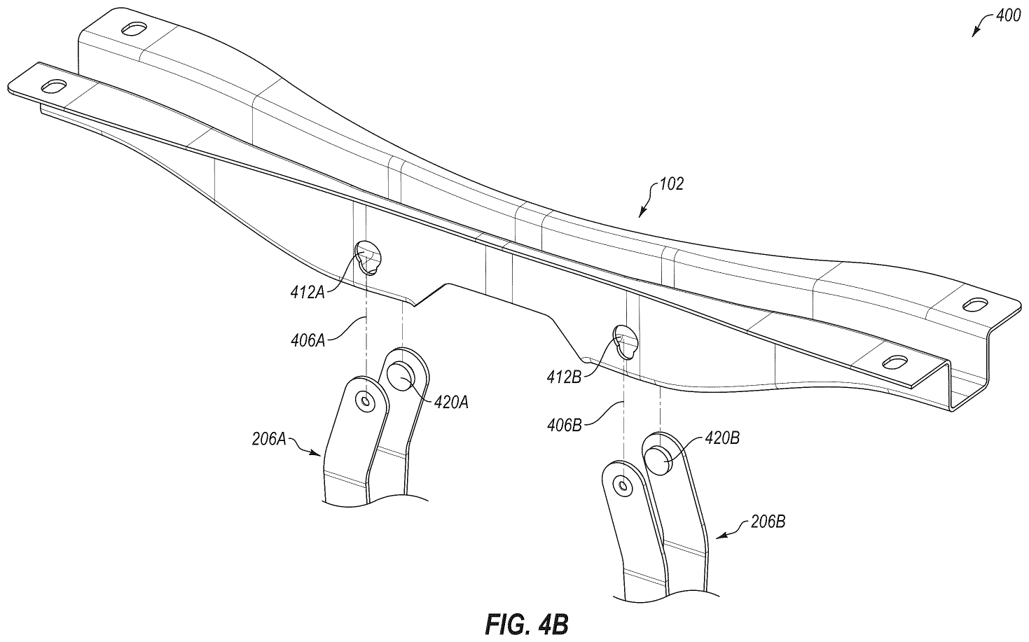

The mounting rail 102 includes two attaching locations 108, a first attaching location 108A and a second attaching location 108B. In some embodiments, the mounting rail 102 may include any number of attaching locations 108. In some embodiments, the attaching locations 108 may refer to locations, points, portions, or sections along the mounting rail 102 where one or more of the straps 206 may attach. For example, the first attaching location 108A may include a section on either side of the mounting rail 102 where one of the straps 206 may attach. In some embodiments, the first attachment location 108A and the second attachment location 108B may indicate a particular location on or section of the mounting rail 102 where different attaching mechanisms may be used to attach the straps 206 (e.g., the first strap 206A and the second strap 206B). As shown in FIG. 1, one or more attaching mechanisms may be used to attach the first and second straps 206A and 206B to the mounting rail 102 at the first and second attaching locations 108A and 108B including, for example, pins and holes, rivets and keyholes, screws, anchors, etc. Exemplary attaching mechanisms or methods of attaching the straps 206 to the mounting rail 102 may be described and/or illustrated further in the present disclosure, such as, for example, with respect to FIGS. 4A-4B. As shown in FIG. 1, the two attaching locations 108 attach a first strap 206A and a second strap 206B to the mounting rail 102.

The first and second straps 206A and 206B (referred to collectively as “the straps 206”) may be configured to attach to the mounting rail 102. As shown in FIG. 1, the straps 206 attach to the mounting rail 102 on either side of the torque tube 104. In FIG. 1, the second strap 206B which is visible and therefore exemplary, includes a first end attached to a first side of the mounting rail 102 at attaching location 108B and a second end attached to a second side of the mounting rail 102 at attaching location 108B. In some embodiments, the straps 206 may each include a cross-sectional shape that includes a shorter edge and a longer edge, where the shorter edge is configured to interface with one or more outer edges of the torque tube 104. In FIG. 1, for example, the torque tube 104 includes an octagonal shape and, therefore, the shorter edges of the straps 206 may be shaped and oriented to conform to the octagonal shape of the torque tube 104. This is true of other embodiments as well where the shorter edges of the straps 206 may be shaped and oriented to engage with outer sides or edges of the torque tube 104, whatever the shape.

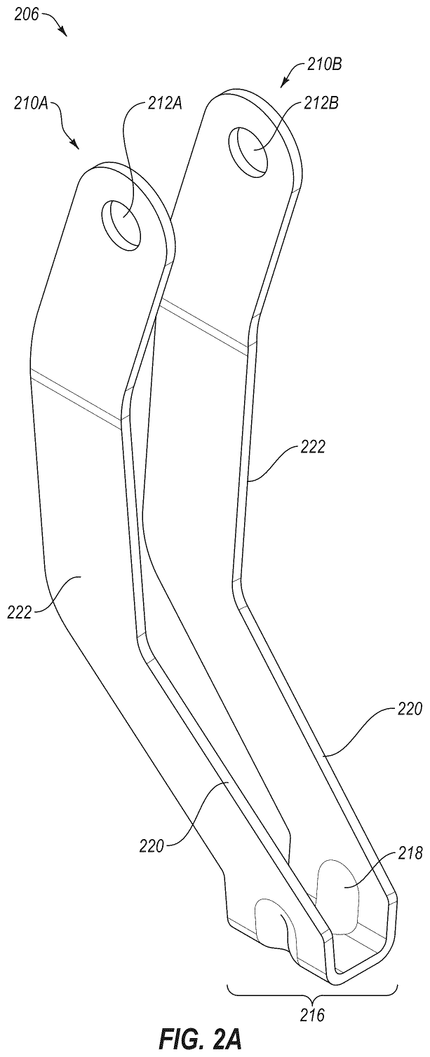

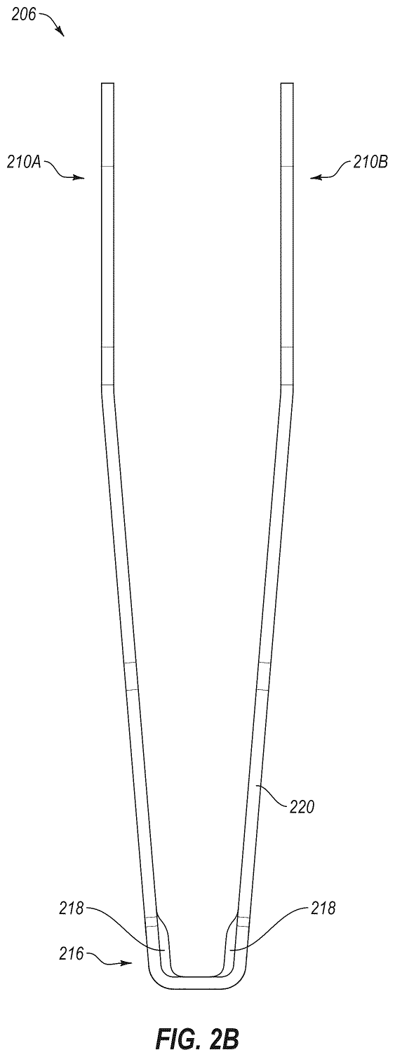

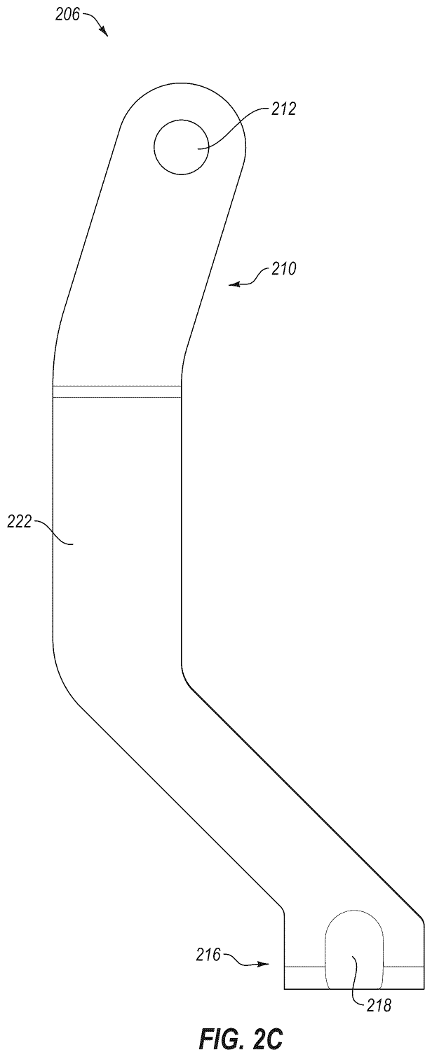

The second strap 206B may include one or more bends such that a connecting portion 216 may be created. In some embodiments, connecting portion 216 corresponding to the second strap 206B may be connected with a connecting portion 216 corresponding to the first strap 206A using a fastener 320. In some embodiments, the connecting portion 216 may include a same or similar cross-sectional shape and may therefore include one or more shorter edges and one or more longer edges. In some embodiments, including the shorter edges of the connecting portion 216 may allow a head of the fastener 320 to engage with the shorter edges of the connecting portion 216. For example, the head of the fastener 320 may engage with each of the three shorter edges of the connecting portion 216. Further, in some embodiments, the longer edge of the connecting portion 216 may increase strength and resistance to deformation of the connecting portions 216 without using additional material to force the fastener 320 down and away from the torque tube 104. Exemplary straps 206 may be described and/or illustrated further in the present disclosure, such as, for example, with respect to FIGS. 2A-4B. As shown in FIG. 1, in an engaged state, the torque tube 104 is secured to the mounting rail 102 using the first and second straps 206A and 206B connected using the fastener 320.

Modifications, additions, or omissions may be made to the system 100 without departing from the scope of the disclosure. For example, another system for securing torque tubes to mounting rails, a torque tube and/or mounting rail may each be a different size, shape, or orientation than what is depicted in FIG. 1. In addition, the number of attaching locations 108 and/or mechanisms designed to attach the straps 206 to the mounting rail 102 may vary. The designations of different elements in the manner described is meant to help explain concepts described herein and is not limiting. Further, the system 100 may include any number of other elements or may be implemented within other systems or contexts than those described.

FIGS. 2A-2C illustrate various views of one of the straps 206 (e.g., the first or second straps 206A or 206B) shown in FIG. 1. As referred to throughout the description of FIGS. 2A-2C “the strap 206” refers to one of the straps 206 described and/or illustrated in FIG. 1. Specifically, FIG. 2A illustrates a perspective view of the strap 206. FIG. 2B illustrates a front view of the strap 206. FIG. 2C illustrates a side view of the strap 206.

The strap 206 may be integrally formed. In some embodiments, the strap 206 may be constructed of a single piece of material; for example, the strap 206 may be machined, cut, shaped, etc. from a single sheet of metal (e.g., aluminum, steel, galvanized steel, titanium, etc.) or one or more other plastic or composite materials. In some embodiments, by forming the strap 206 from a single sheet of metal or a single piece of material, the cost of manufacturing the strap 206 may decrease and an amount of material used to manufacture the straps 206 may also decrease as a result. In some embodiments, the strap 206 may be constructed of several different pieces that may be welded together or otherwise connected or attached to form the strap 206. For example, a portion of the strap 206 that may be configured to attach to the mounting rail 102 may be separate from the remainder of the strap 206 and may be welded or otherwise attached to the remaining portions of the strap 206. As another example, the connecting portion 216 may be formed or constructed separately from the remaining portions of the strap 206 and may be welded or otherwise attached to the remaining portions of the strap 206.

In some embodiments, the strap 206 may include a first end 210A and a second end 210B (collectively the “ends 210”). In some embodiments, the first and second ends 210A and 210B may be configured to attach to the mounting rail 102—e.g., at one or more of the attaching locations 108. In some embodiments, the first end 210A may be configured to attach to a first side of the mounting rail 102 and the second end 210B may be configured to attach to a second side of the mounting rail 102. For example, and as shown in FIG. 2A, the first end 210A defines a first hole 212A and the second end defines a second hole 212B (collectively the “holes 212”). In some embodiments, the holes 212 may be configured to receive one or more pins, rods, dowels, etc. that may be inserted through the first and/or second holes 212A and/or 212B and corresponding holes in the mounting rail 102. In some embodiments, the holes 212 may define keyholes configured to receive one or more rivets attached to the mounting rail 102. The first and second ends 210A and 210B may include or define several different methods or mechanisms with which the strap 206 may be attached to the mounting rail 102. Exemplary methods or mechanisms with which to attach the strap 206 to the mounting rail 102 may be described and/or illustrated further in the present disclosure such as, for example, with respect to FIGS. 4A-4B.

In some embodiments, the strap 206 may include a cross-sectional shape such that the strap 206 includes a shorter edge 220 and a longer edge 222. In some embodiments, the straps 206 may include a rectangular cross-sectional shape or a substantially rectangular cross-sectional shape where the cross-sectional shape includes a shorter edge and a longer edge. In some embodiments, the cross-sectional shape may be substantially rectangular. For example, the rectangular cross-section may be modified or otherwise reinforced such as, for example, using a bead weld, including additional reinforcing material, or other technique. Additionally or alternatively, the cross-sectional shape may be one or more other shapes such as, for example, circular, ellipsoidal, trapezoidal, polygonal, to name a few.

The shorter edge 220 of the strap 206 may be formed and/or oriented to interface with the torque tube 104. As shown in FIG. 1, the torque tube 104 may include an octagonal cross-section and the strap 206 shown, for example, in FIGS. 1 and 2A-2C, is shaped and oriented such that the shorter edge 222 may interface with an outer edge of the torque tube 104. In some embodiments, the shorter edge 220 may be beveled or rounded, concave, straight, square, or otherwise shaped to interface with or accommodate an outer edge of the torque tube 104. The shorter edge 222 may include a consistent thickness on all sides of the strap 206. Additionally or alternatively, the shorter edge 222 may include variable thicknesses along sides of the strap 206. For example, the shorter edge 222 closer to the first and second ends 210A and 210B may be thicker or thinner than other portions of the strap 206. As an additional example, the shorter edge 222 closer to the connecting portion 216 may be thicker or thinner than other portions of the strap 206.

The longer edge 222 of the strap 206 may represent a width of the strap 206. In some embodiments, the longer edge 222 of the strap 206 may be consistent or the same throughout the strap 206. In some embodiments, the longer edge 222 may be variable throughout the strap. For example, the longer edge 222 corresponding to the connecting portion 216 may be longer than the longer edge 222 corresponding to one or more other portions of the strap 206. For example, a width of the strap 206 corresponding to the connecting portion 216 may be larger than a width corresponding to one or more other portions of the strap 206. In some embodiments, the longer edge 222 may be larger to reinforce one or more portions of the strap 206—for example, the connecting portion 216.

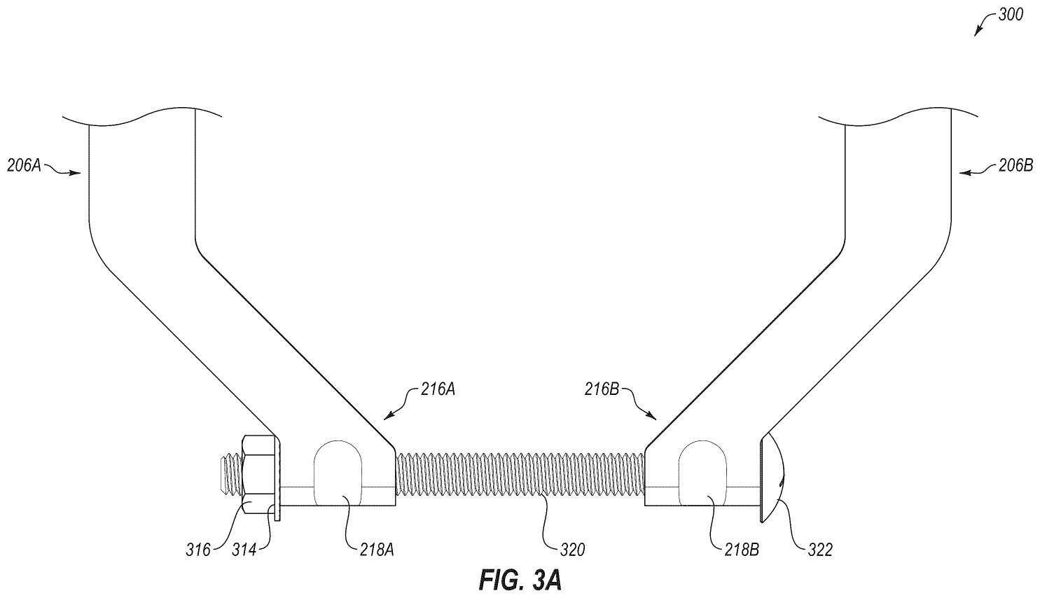

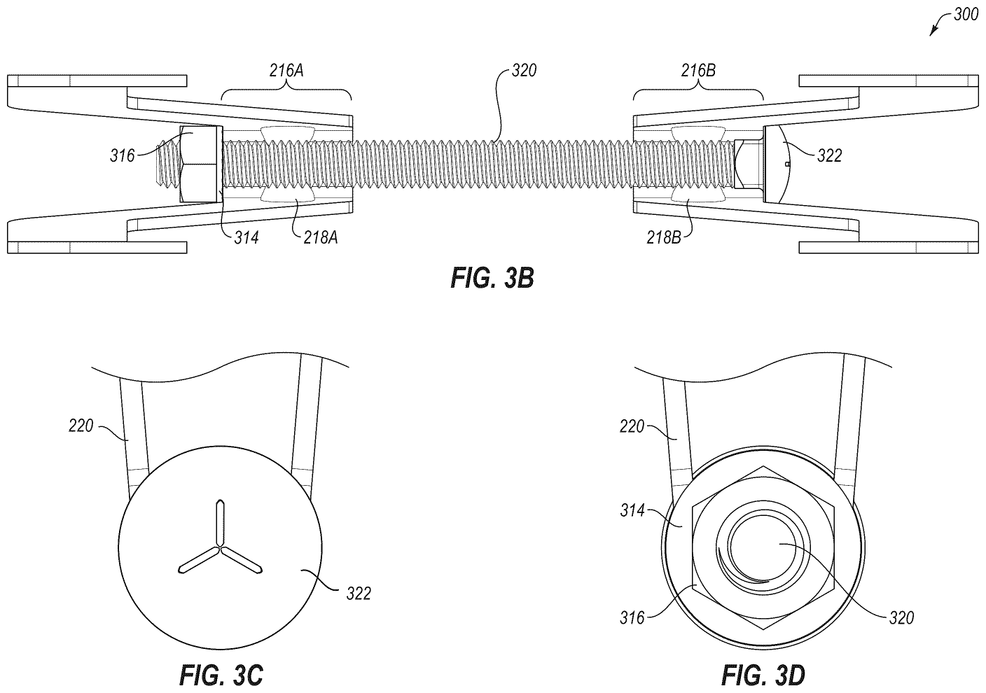

The connecting portion 216 is configured to receive or seat one or more fasteners (e.g., the fastener 320). In instances where the strap 206 is formed using a single piece of metal or other material, the connecting portion 216 may be formed by bending or forming the piece of metal thereby creating the connecting portion 216. In FIG. 1, the connecting portion 216 may interface with the fastener 320 on one or more of the three sides of the connecting portion 216. In some embodiments, the fastener 320 may interface with each of the three sides of the connecting portion 216 thereby seating the fastener within the connecting portion 216. In some embodiments, and as shown in FIG. 1, each of the two straps 206 include connecting portions 216 and are each configured to seat the fastener 320 to secure the torque tube—e.g., the torque tube 104. In some embodiments, the connecting portion 216 includes one or more embossed features 218. The embossed feature(s) 218 may be used to center, stabilize, or secure the fastener 320 in the strap 206. In some embodiments, the embossed feature(s) 218 may be threaded to assist in securing the fastener 320 and help to connect the straps 206 together. In some embodiments, the fastener 320 and connecting the two straps 206 may be described and/or illustrated further in the present disclosure, such as, for example, with respect to FIGS. 3A-3D.

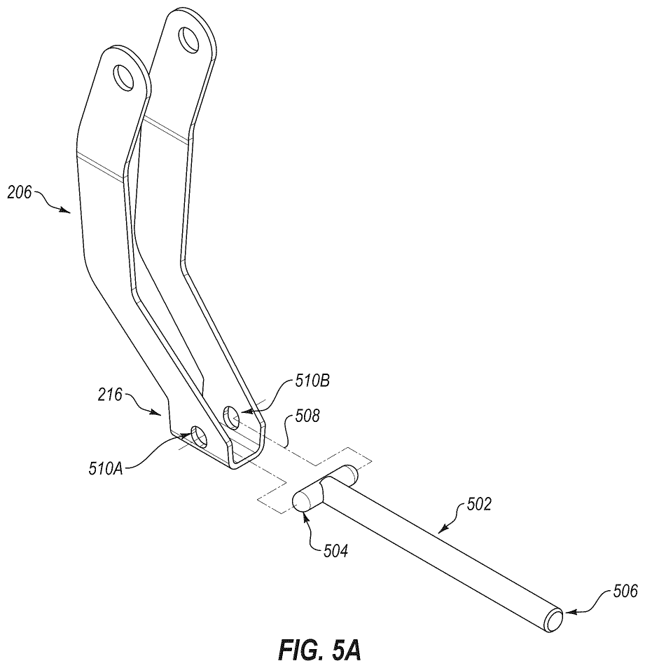

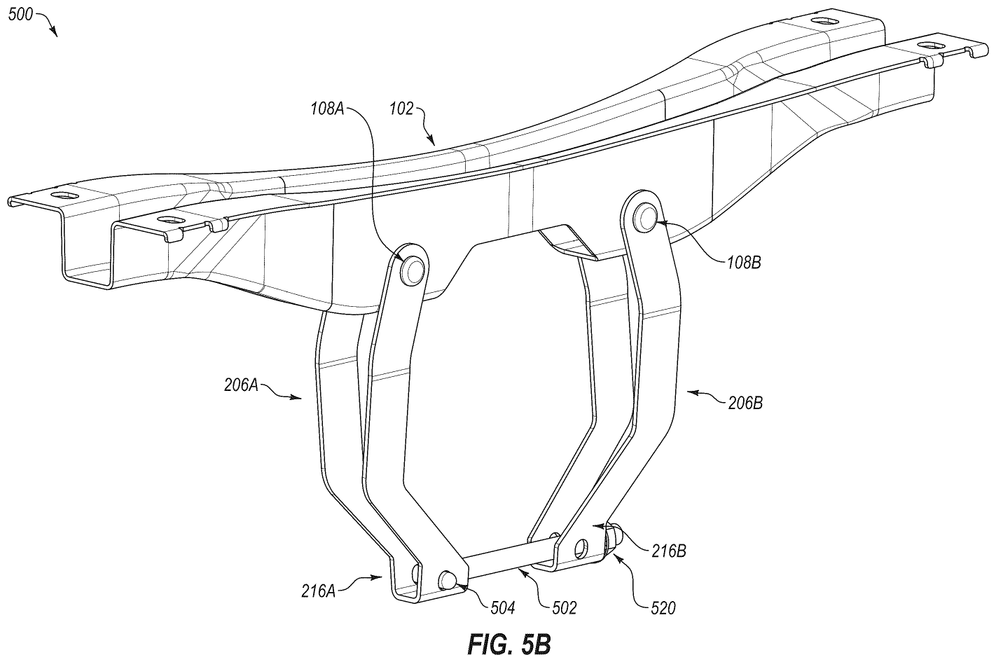

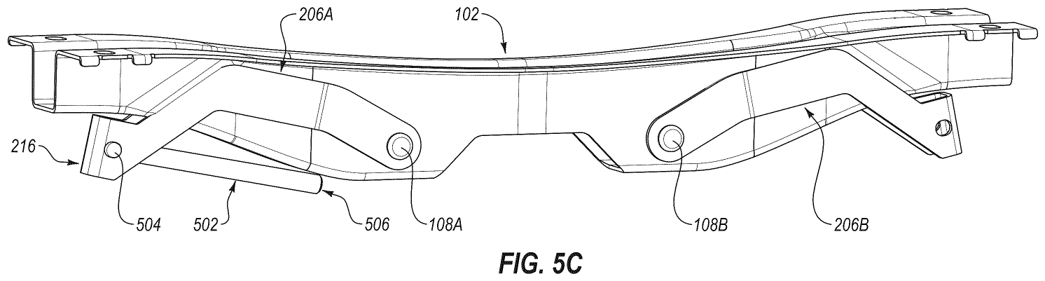

In some embodiments, the connecting portion 216 may additionally accommodate one or more other structures to connect the straps 206 together. In some embodiments, the connecting portion 216 may be configured to seat a T-bolt or equivalent structures for example, the T-bolt 502 described and/or illustrated further in the present disclosure such as, for example, with respect to FIGS. 5A-5C.

FIGS. 3A-3D illustrate the fastener 320 connecting the first and second straps 206A and 206B as shown in FIG. 1. FIG. 3A illustrates a side view of the fastener 320 connecting the first and second straps 206A and 206B. FIG. 3B illustrates a top view of the first and second straps 206A and 206B connected using the fastener 320. FIG. 3C illustrates a front view of the fastener 320 connecting the straps 206. FIG. 3D illustrates a rear view of the fastener 320 connecting the straps 206.

As shown in FIG. 3A, the fastener 320 connects to the first and second straps 206A and 206B. The first strap 206A includes a first connecting portion 216A and the second strap 206B includes a second connecting portion 216B where the first and second connecting portions 216A and 216B may be the same as and/or analogous to the connecting portion 216 described and/or illustrated further in the present disclosure such as, for example, with respect to FIGS. 1 and 2A-2C. The fastener 320 includes a first end that is placed or seated in the first connecting portion 216A of the first strap 206A and a second end of the fastener 320 is placed or seated in the second connecting portion 216B of the second strap 206B. In some embodiments, the fastener 320 includes a fastener head 322, a nut 316, and a washer 314 where the fastener head 322 may correspond to the second end of the fastener 320 and the nut 316 and washer 314 corresponding to the first end of the fastener 320.

As shown, for example, in FIG. 3C, the fastener head 322 may extend over the shorter edge 220 of the second connecting portion 216B such that, in an engaged state, the fastener head 322 may apply a compression force to the second connecting portion 216B and thereby allow the fastener 320 to engage the second connecting portion 216B. As shown, for example, in FIG. 3D, the washer 314 may extend over the shorter edge 220 of the first connecting portion 216A such that, in an engaged state, the washer 314 combined with the nut 316 may apply a compression force opposite the compression force applied by the fastener head 322 to the second connecting portion 216B, thereby allowing the fastener 320 to engage the first connecting portion 216A. In some embodiments, the compression force applied by the nut 316 and the washer 314 and, correspondingly, the fastener head 322 may be varied based on the torque applied to the nut 316. In some embodiments, the width or sizes of the longer edge 222 of the first and second connecting portions 216A and 216B may be determined or constructed based on the compression force applied to the first and second connecting portions 216A and 216B. The force applied, for example, by the nut 316, washer 314, and fastener head 322. In some embodiments, the cross-sectional shape of the first and second straps 206A and 206B that includes a shorter edge and a longer edge may enable the fastener 320 to remain close to the underside of the torque tube 104 while also reinforcing the connecting portions 216 from the compression force applied by the nut 316, the washer 314, and the fastener head 322. And, by elongating the longer edges, the first and second straps 206A and 206B may be more resistant to deformation than straps 206 with a smaller width or decreased length of the longer edge 222.

The fastener 320 depicted in FIGS. 3A-3D includes a threaded bolt. The threaded bolt is exemplary. In some embodiments, the fastener 320 may include different types of fasteners including, for example, a screw, a bolt, a T-bolt, an anchor, a pin, a clip, a hinge clip, a hook, a threaded insert, a dowel, a rod, a cable tie, or any other kind of fastener. The fastener 320 may include any type of structure configured to be seated or placed in the first and second connecting portions 216A and 216B and secured such that, in an engaged state, the first and second straps 206A and 206B along with the fastener 320 secures the torque tube 104 to the mounting rail 102.

Modifications, additions, or omissions may be made to the fastener 320 and/or the straps 206 without departing from the scope of the present disclosure. For example, in some embodiments, a fastener may lack a washer or the straps 206 may include additional components similar to the components illustrated in FIGS. 2A-2C. For example, sizes, thicknesses, shape, and orientation of the straps 206—e.g., the shorter edge 220, the longer edge 222, the first and second ends 210A and 210B—may vary. In addition, the fastener 320 may include one or more different types of fasteners or mechanisms for connecting the first and second straps 206A and 206B.

FIGS. 4A-4B illustrate exemplary attaching portions or mechanisms for attaching the first and second straps 206A and 206B to the mounting rail 102. Embodiments disclosed herein may illustrate various methods and mechanisms for attaching the first and second straps 206A and 206B. As shown in FIG. 4A, the first and second straps 206A and 206B may include corresponding first and second attaching portions 410A and 410B each indicating a portion of the first or second strap 206A or 206B configured to attach to the mounting rail 102. To attach the first and second attaching portions 410A an 410B, the first and second straps 206A and 206B may be raised (e.g., shown by dotted lines 406A and 406B) to corresponding portions or sections of the mounting rail 102—e.g., the first and second attaching locations 108A and 108B described and illustrated in FIG. 1. In FIG. 4A, the first attaching portion 206A may define one or more holes to accommodate a first pin 404A and the second attaching portion 206B may define one or more holes to accommodate a second pin 404B. In addition and correspondingly, the mounting rail 102 may define a first set of holes 408A and a second set of holes 408B individually configured to accommodate the first and second pin 404A and 404B, respectively. In an engaged state, the first attaching portion 410A is attached to the mounting rail 102 at the first set of holes 408A using the first pin 404A. And the second attaching portion 410B is attached to the mounting rail 102 at the second set of holes 408A using the second pin 404A. In some embodiments, the first and second pins 404A and 404B may include one or more pins, rods, dowels, screws, anchors, etc.

In FIG. 4B, the first and second attaching portions 410A and 410B are attached to the mounting rail 102 using keyholes 412 and rivets 420. In some embodiments, the first attaching portion 410A includes a first set of rivets 420A and the second attaching portion 410B includes a second set of rivets 420B facing inward toward each other. The mounting rail 102 includes a first set of keyholes 412A and a second set of keyholes 412B each configured to receive the first and second set of rivets 420A and 420B, respectively. In some embodiments, by sliding the rivets 420 into corresponding keyholes 412, the first and second straps 206A and 206B may hang from the mounting rail 102 without detaching. In some embodiments, the rivets 420 may face outward and the mounting rail 102 may include corresponding keyholes 412 and may receive the rivets from one or more inside surfaces. Alternatively, the rivets 412 may correspond to the mounting rail 102 and the first and second attaching portions 410A and 410B may define corresponding keyholes 412 configured to receive the rivets 420.

FIGS. 5A-5C illustrate an example configuration of the straps 206 including a connecting portion 216 capable of accommodating a T-bolt 502 to connect the first and second straps 206 around a torque tube 104. The connecting portion 216 described with respect to FIGS. 5A-5C is an example of the connecting portion 216 described further in the present disclosure, such as, for example, with respect to FIGS. 1-3C.

The T-bolt 502 includes a proximal end 504 and a distal end 506, the proximal end 504 may be shaped to attach to the connecting portion 216. In some embodiments, the proximal end 504 of the T-bolt 502 includes a portion that is cylindrically shaped and positioned perpendicular to the remainder of the T-bolt 502. As shown in FIG. 5A, the proximal end 504 that may be oriented perpendicular or substantially perpendicular to the remainder of the T-bolt 502. In some embodiments, the proximal end 504 may include different cross-sectional shapes—e.g., circular, square, rectangular, to name a few. In some embodiments, the proximal end 504 of the T-bolt 502 attaches to the connecting portion 216.

The distal end 506 of the T-bolt 502 may be configured to be seated into the connecting portion 216 of a second strap 206. For example, as shown in FIG. 5B, the proximal end 504 of the T-bolt 502 is attached to the first connecting portion 216A of a first strap 206A and the distal end 506 of the T-bolt 502 is seated in the second connecting portion 216B of a second strap 206B. In some embodiments, the distal end 506 of the T-bolt 502 may be threaded or include structures to secure the distal end 506 of the T-bolt 502 to the second connecting portion 216B. For example, as shown in FIG. 5B, the distal end 506 is secured to the second connecting portion 216B using a nut and washer 520. In some embodiments, the distal end 506 may not include any threads and the distal end 506 may be secured to the second connecting portion 216B using one or more other methods or devices that may tighten the first and second straps 206A and 206B around a torque tube and secure the T-bolt 502 in place. For example, one or more collars with set screws, push nuts, knurled nuts, spring nuts, wedge nuts, etc.

In some embodiments, the connecting portion 216 defines a first hole 510A and a second hole 510B (collectively the holes 510), one on either side of the connecting portion 216. In some embodiments, the holes 510 may be defined to accommodate a horizontal portion of the T-bolt 502. As shown in FIG. 5A, the holes 510 are circular, or substantially circular. In some embodiments, the holes 510 may be defined based on the shape of the proximal end 504 of the T-bolt 502, whatever the shape (for example, the holes 510 may define a number of shapes including rectangular, polygonal, hexagonal, octagonal, etc.). In some embodiments, the holes 510 may be configured to receive the proximal end 504 of the T-bolt 502.

In some embodiments, as shown in FIG. 5A, the proximal end 504 of the T-bolt 502 may be inserted through the holes 510 such that the T-bolt 502 is seated in the connecting portion 216 through the holes 510 as shown by the dotted lines 508. In some embodiments, to install the proximal end 504 of the T-bolt 502 in the connecting portion 216, the strap 206 may be bent around the horizontal portion 504 in such a way that the proximal end 504 extends through both of the holes 510.

Additionally or alternatively, the proximal end 504 of the T-bolt 502 may be attached to the connecting portion 216 in one or more other ways. For example, the proximal end 504 may be inserted into the respective holes 510 and welded to the connecting portion 216. In some embodiments, the proximal end 504 may be inserted into respective holes 510 and bent or otherwise deformed to secure the proximal end 504 of the T-bolt 502 to the connecting portion 216. In some embodiments, the proximal end 504 may be inserted into the holes 510 and the proximal end 504 may be configured to receive the remaining portion of the T-bolt 502, such as, for example, using threads or other connection mechanisms to connect the remaining portion of the T-bolt 502 to the proximal end 504.

In some embodiments, the T-bolt 502 may be configured to rotate about an axis that may be defined through the holes 510. In some embodiments, the ability to rotate the T-bolt 502 may assist in efficient and easy storage and transportation of the mounting rail 102. In FIG. 5C, for example, an example configuration of the mounting rail 102 is shown where the straps 206 are stored with the mounting rail 102. In some instances, by storing the straps 206 with the mounting rail 102, field assembly and cost may decrease given that the straps 206 may be attached to the mounting rail 102 prior to installation. In addition, in some instances, the T-bolt 502 may be stored along with the straps 206 as shown in FIG. 5B. Storage of the T-bolt 502 along with the straps 206 further eases installation costs. Further, storing the T-bolt 502 in this manner allows the straps 206 to be bent around the T-bolt 502, stored, and transported with the mounting rail 502. In some embodiments, to store the straps 206 and the T-bolt 502, the straps 206 may be attached to the mounting rail 102 such that the straps 206 may rotate about the attaching locations 108. In some embodiments, the straps 206 may rotate out and away from each other and rest nearer the top flanges of the mounting rail 102. In addition, the T-bolt 502 may be configured to rotate about an axis that is defined through both the first and second holes 510. In some embodiments, by rotating, the T-bolt 502 may rest in a stored position closer to the mounting rail 102 than it otherwise would in an engaged configuration, such as, for example, the position illustrated with respect to FIG. 5B.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the summary, detailed description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absent a showing that the terms “first,” “second,” “third,” etc., connote a specific order, these terms should not be understood to connote a specific order. Furthermore, absent a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

The foregoing description, for purpose of explanation, has been described with reference to specific embodiments. However, the illustrative discussions above are not intended to be exhaustive or to limit the invention as claimed to the precise forms disclosed. Many modifications and variations are possible in view of the above teachings. The embodiments were chosen and described to explain practical applications, to thereby enable others skilled in the art to utilize the invention as claimed and various embodiments with various modifications as may be suited to the particular use contemplated.

1. A system for mounting photovoltaic (PV) modules to a torque tube, the system comprising:
a mounting rail configured to be secured to a PV module;
a first strap having a proximal end, a distal end, a shorter edge, and a longer edge, the first strap being oriented such that the shorter edge of the first strap is configured to interface with the torque tube, wherein the proximal end of the first strap is coupled to the mounting rail and the distal end includes a connecting portion;
a second strap having a proximal end, a distal end, a shorter edge, and a longer edge, the second strap being oriented such that the shorter edge of the second strap is configured to interface with the torque tube, wherein the proximal end of the second strap is coupled to the mounting rail and the distal end includes a connecting portion; and
a fastener that couples the connecting portion of the first strap to the connecting portion of the second strap.

2. The system for mounting PV modules of claim 1, wherein the first strap and the second strap include a rectangular cross-sectional shape.

3. The system for mounting PV modules of claim 1, wherein the connecting portion of the first strap or the connecting portion of the second strap is shaped such that three shorter edges of the connecting portion are configured to interface with a head of the fastener.

4. The system for mounting PV modules of claim 1, wherein the connecting portion of the first and second strap each includes one or more embossed features configured to seat the fastener.

5. The system for mounting PV modules of claim 1, wherein:
the proximal ends of the first and second straps individually define a keyhole slot configured to receive a rivet; and
the mounting rail includes a plurality of rivets individually configured to be inserted into corresponding keyhole slots defined in the proximal ends of the first and second straps.

6. The system for mounting PV modules of claim 1, wherein:
the proximal ends of the first and second straps individually define a hole configured to receive a pin and the mounting rail defines a hole corresponding to each of the holes defined in the proximal ends of the first strap and the second strap; and
the system for mounting PV modules further includes a first pin configured to be inserted into the holes defined in the proximal end of the first strap and the mounting rail and a second pin configured to be inserted into the holes defined in the proximal end of the second strap and the mounting rail.

7. The system for mounting PV modules of claim 1, wherein the fastener is selected from a group consisting of a screw, a bolt, a T-bolt, an anchor, a pin, a clip, a hinge clip, a hook, a threaded insert, a dowel, a rod, and a cable tie.

8. The system for mounting PV modules of claim 1, wherein the connecting portion of the first strap and the second strap includes a width, the width being determined based on an amount of compression force applied by the fastener on the connecting portions of the first and second straps.

9. The system for mounting PV modules of claim 1, wherein the first strap is integrally formed, and the second strap is integrally formed.

10. A system for mounting photovoltaic (PV) modules to a torque tube, the system comprising:
a mounting rail configured to be secured to a PV module;
a first strap having a first end, a second end, and a shorter edge, and a longer edge, the first strap including one or more bends forming a first connecting portion between the first and second ends, wherein the first and second ends are secured to the mounting rail;
a second strap having a first end, a second end, a shorter edge, and a longer edge, the second strap including one or more bends forming a second connecting portion between the first and second ends, wherein the first and second ends are secured to the mounting rail; and
a fastener that couples the first connecting portion to the second connecting portion, such that in a coupled configuration, the first and second straps form torque tube clamps and are configured to secure the mounting rail to a torque tube.

11. The system for mounting PV modules of claim 10, wherein each of the first and second connecting portions seats the fastener such that the fastener interfaces with three edges of each of the first and second connecting portions.

12. The system for mounting PV modules of claim 10, wherein:
the fastener is a T-bolt that includes a proximal end and a distal end, the proximal end being substantially perpendicular to the distal end;
the first connecting portion defines a first hole and a second hole configured to receive the proximal end of the T-bolt; and
the second connecting portion is configured to seat the distal end of the T-bolt.

13. The system for mounting PV modules of claim 12, wherein:
the first strap and the second strap rotate about the first and second ends of the first strap and the second strap, respectively; and
the T-bolt is configured to rotate about an axis running through both the first and second holes such that, in a stored configuration, the first strap, the second strap, and the T-bolt rotate closer to the mounting rail in the stored configuration than in an engaged configuration.

14. The system for mounting PV modules of claim 10, wherein:
the first and second ends of the first strap and the second strap each defines a keyhole slot configured to receive a rivet; and
the mounting rail includes a plurality of rivets each configured to be inserted into corresponding keyhole slots defined in the first and second ends of the first and second straps.

15. The system for mounting PV modules of claim 10, wherein:
the first and second ends of the first strap and the second strap each defines a hole configured to receive a pin and the mounting rail defines a hole corresponding to each of the holes defined in the first and second ends of the first strap and the second strap; and
the system for mounting PV modules further includes a first pin configured to be inserted into the holes defined in the first and second ends of the first strap and the mounting rail and a second pin configured to be inserted into the holes defined in the first and second ends of the second strap and the mounting rail.

16. The system for mounting PV modules of claim 10, wherein a width of a longer edge of the first and second connecting portions is determined based on an amount of compression force applied by the fastener on the first and second strap.

17. A system for mounting photovoltaic (PV) modules to a torque tube, the system comprising:
a first strap having a first end and a second end, the first strap including one or more bends forming a first connecting portion between the first and second ends, wherein the first and second ends are configured to be secured to a mounting rail;
a second strap having a first end and a second end, the second strap including one or more bends forming a second connecting portion between the first and second ends, wherein the first and second ends are configured to be secured to the mounting rail; and
a fastener that couples the first connecting portion to the second connecting portion, such that in a coupled configuration, the first and second straps are configured to secure the mounting rail to a torque tube.

18. The system for mounting PV modules of claim 17, wherein the connecting portions of the first strap and the second strap each include one or more embossed features configured to seat the fastener.

19. The system for mounting PV modules of claim 17, wherein:
the first and second attaching portions of the first strap and the second strap individually defines a keyhole slot configured to receive a rivet; and
the mounting rail includes a plurality of rivets each configured to be inserted into corresponding keyhole slots defined in the first and second attaching portions of the first and second straps.

20. The system for mounting PV modules of claim 17, wherein:
the mounting rail defines one or more key hole slots configured to receive a rivet; and
the first and second attaching portions of the first strap and the second strap individually include one or more rivets each configured to be inserted into corresponding keyhole slots defined in the mounting rail.
